(19) United States
(12) Patent Application Publication
(10) Pub. No.: US 2016/0256798 A1
(43) Pub. Date: Sep. 8, 2016

(54) Variable Speed Torque Monitoring Inline Mixer

(71) Applicant: Paterson & Cooke Ideas, Ltd., Golden, CO (US)

(72) Inventors: Robert Cooke, Golden, CO (US); Christian Kujawa, Golden, CO (US); Michael A. Cook, Golden, CO (US); Benjamin O. Nicoara, Golden, CO (US)

(21) Appl. No.: 15/060,190

(22) Filed: Mar. 3, 2016

Related U.S. Application Data
(60) Provisional application No. 62/127,515, filed on Mar. 3, 2015.

(51) Int. Cl. B01D 21/01; B01F 15/00; B01D 21/30; B01F 7/00

(52) U.S. Cl. CPC B01D 21/01; B01F 7/00908; B01F 15/00389; B01D 21/302

(57) ABSTRACT

An inline mixer that can monitor and adjust its output torque and speed in real time to adjust mixing properties to suit changing fluids flowing therethrough. In one embodiment, structures can be constructed to provide different mixing characteristics via different shapes, configurations, and spacing, which can be formed therein and such structures can optionally be replaced to further customize mixing properties.

### CROSS-REFERENCE TO RELATED APPLICATIONS

This application claims priority to and the benefit of the filing of U.S. Provisional Patent Application Ser. No. 62/127,515, entitled “Variable Speed Torque Monitoring Inline Mixer”, filed on Mar. 3, 2015, and the specification and claims thereof are incorporated herein by reference.

### BACKGROUND OF THE INVENTION

### Field of the Invention (Technical Field):

Embodiments of the present invention relate to a variable rotational speed and torque monitoring inline mixer, particularly an inline mixer which provides especially desirable results for mixing slurries at desired energy input or shear rate ranges.

### BRIEF SUMMARY OF EMBODIMENTS OF THE PRESENT INVENTION

Embodiments of the present invention provide desirable results when used in, but not limited to, the following applications:

1) Mixing fluids and polymers.

2) Mixing flocculated slurries (solid-liquid mixtures) to achieve rheology reduction.

3) Mixing differing liquids and slurries for various process applications.

4) Indication of fluid rheology.

5) Conditioning of liquid or slurry systems.

6) Reactor for chemical reactions.

7) Emulsification of oil/water or oil/water/solids systems.

An embodiment of the present invention relates to an inline mixer apparatus having a variable speed drive unit, a spindle, a housing, an inlet, a torque monitoring circuit for monitoring torque on the spindle, and a rotational speed adjusting circuit for adjusting torque on the spindle. The mixer apparatus can also have a plurality of structures for inducing mixing. And, at least some of the structures can be disposed on the spindle. Optionally, at least some of the structures can be disposed on an outer portion of the inlet. A cage comprising one or more structures for inducing mixing can also be provided. The cage can include an at least substantially cylindrical shape wherein an outer diameter of the cage is less than an inside diameter of the housing. One or more structures can be disposed on the cage. In one embodiment, the variable speed drive unit can include a variable speed drive motor and/or an adjustable transmission drive unit.

An embodiment of the present invention also relates to an inline mixing system having an electrically-powered inline mixer, which itself has at least one shaft communicably rotationally-coupled to transmit energy to a fluid passing therethrough; and a torque control system which has a system for monitoring torque transmitted through the shaft; and a feedback loop for adjusting power to the electrically-powered inline mixer to adjust torque in the shaft to meet desired criteria, which can optionally include one or more user-adjustable parameters, one or more user-defined magnitudes, and/or one or more predetermined magnitudes.

An embodiment of the present invention also relates to a method for mixing a fluid that includes providing an inline mixer comprising a shaft, monitoring torque on the shaft during a mixing process, and adjusting a torque output of the inline mixer based on the monitored torque and a predetermined torque parameter. In one embodiment, providing an inline mixer can include providing an inline mixer having a variable speed drive unit. Optionally, the predetermined torque parameter can include a user-defined variable. The step of adjusting a torque output of the inline mixer can include adjusting power to an electric motor of the inline mixer and/or causing an adjustable transmission drive unit to change a torque of its output. Optionally, adjusting a torque output comprises automatically adjusting a torque output via a microcontroller.

The method can be useful for mixing a fluid, mixing flocculant with a fluid, mixing a polymer with the fluid, mixing fine tailings and a polymer, and/or mixing mature fine tailings and a polymer. Optionally, the polymer can be introduced and/or injected into the fluid.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side-view drawing with a partially cut-away portion such that the internal flow path of the mixer is visible according to an embodiment of the present invention;

FIG. 2 is a schematic drawing which illustrates an inline mixing process according to an embodiment of the present invention;

FIG. 3 is a schematic representation of an inline mixer according to an embodiment of the present invention;

FIG. 4 is a cut-away view of a rotational inline mixing chamber according to an embodiment of the present invention;

FIGS. 5A and 5B are drawings which respectively illustrate a top and an isometric view of a horizontally-cut-away section of an inline mixer according to an embodiment of the present invention;

FIGS. 6A and 6B are drawings which respectively illustrate a side and an isometric view of a horizontally cut-away lower portion of an inline mixer according to an embodiment of the present invention;

FIGS. 7A and 7B are drawings which respectively illustrate a side and an isometric view of a horizontally cut-away upper portion of an inline mixer according to an embodiment of the present invention;

FIG. 8A is an isometric view of a vertical mixer according to an embodiment of the present invention which includes a variable speed motor connected to a torque control and measurement mechanism for powering the vertical mixer;

FIGS. 8B, 8C, and 8D are drawings which respectively illustrate front, side, and top views of an inline mixer according to a most-preferred embodiment of the present invention;

FIG. 9A illustrates a partially exploded view that shows components of an inline mixer according to an embodiment of the present invention;

FIG. 9B is a cut-away side-view of an inline mixer according to an embodiment of the present invention;

FIG. 9C is a detail cut-away view of a portion of an inline mixer where the input shaft of the mixer connects to the output shaft of the torque control unit according to an embodiment of the present invention;

FIG. 9D is a detail cut-away view of a lower portion of an inlet of an embodiment of an inline mixer according to the present invention;

FIG. 9E is a detail isometric view drawing of an upper portion of an inline mixer according to an embodiment of the present invention;

FIG. 9F is a top view drawing of a cut-away portion of the mixing chamber of an inline mixer according to a most preferred embodiment of the present invention;

FIGS. 10A, 10B, 10C, 10D, 10E, 10F are drawings which respectively illustrate isometric, bottom, upper cut-away, front, left side, and top views of a chamber housing of an inline mixer according to an embodiment of the present invention;

FIGS. 11A, 11B, and 11C are drawings which respectively illustrate isometric, side, and top perspective views of a mixing cage according to an embodiment of the present invention;

FIGS. 12A, 12B, 12C and 12D are drawings which respectively illustrate isometric, front, side, and top views of an inlet of an inline mixer according to an embodiment of the present invention;

FIGS. 13A, 13B, and 13C, are drawings which respectively illustrate side, horizontally cut-away and vertically cut-away view drawings of a spindle with mixing rods attached to an inner and an outer portion thereof, according to an embodiment of the present invention;

FIGS. 13D and 13E are drawings which respectively illustrate a front and a cut-away view of spindle without mixing rods attached thereto according to an embodiment of the present invention;

FIGS. 13F, 13G, 13H, and 13I are drawings which respectively illustrate side, isometric, front, and top views of a spindle cap according to an embodiment of the present invention;

FIG. 14 is a graph which illustrates torque response curves for a slurry with and without flocculant addition at a constant flow rate through an embodiment of a mixer of the present invention;

FIG. 15 is a drawing which illustrates a computer model which was constructed and used to generate the information in Tables I and II;

FIGS. 16A and 16B are the outputs of computer simulations which respectively illustrate flow profiles of slurry mixing at 350 revolutions per minute and at zero revolutions per minute according to an embodiment of the present invention;

FIGS. 17A and 17B respectively illustrate computer simulations that were performed to illustrate mixing for a slurry at 350 revolutions per minute and at zero revolutions per minute according to an embodiment of the present invention; and

FIG. 18 is an efficiency chart that illustrates mixing efficiency of various systems and apparatuses for mixing a mature fine tailings slurry and polymer.

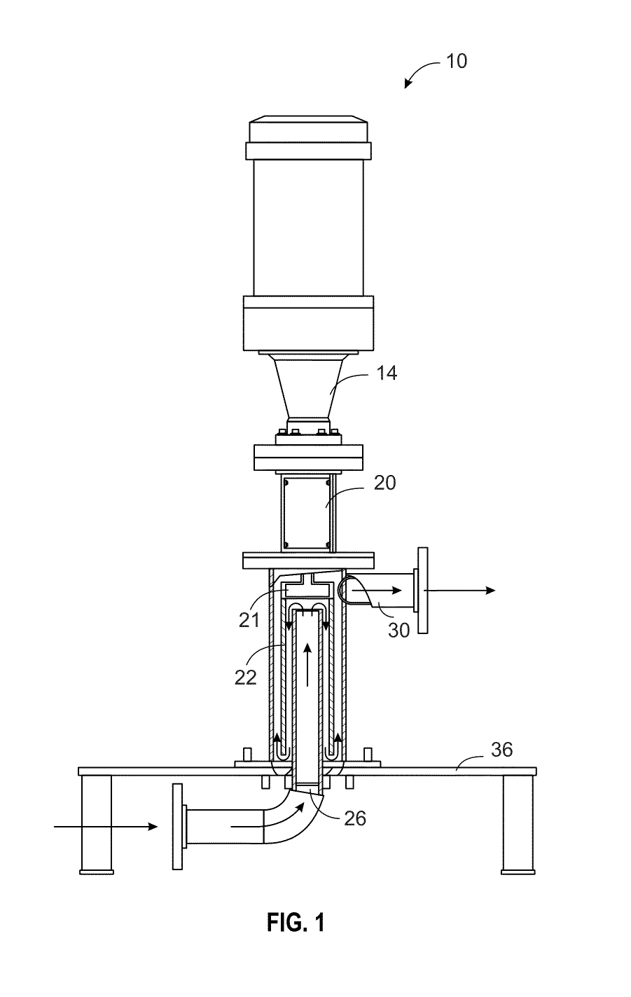

### DETAILED DESCRIPTION OF THE INVENTION

Embodiments of the present invention relate to a variable speed inline mixer which provides desirable results in mixing fluids of various viscosities. In particular, the mixer is well suited for mixing slurry and polymer solutions for inline flocculation applications. The mixing energy and shear rate can be controlled to achieve optimum results.

The term “fluid” as used throughout this application is intended to mean any material that can flow, regardless of whether such material contains purely liquids, or includes gases, slurries formed from solid particles disposed within a liquid, and combinations thereof.

Referring now to the figures generally, an embodiment of the present invention relates to inline mixer 10 having controller 12, which can be a motor controller, communicably coupled to variable speed drive unit 14, which can include a variable speed motor, a gear box, a chain drive, a belt-drive, a variable speed pulley, and/or a transmission. Variable speed drive unit 14 most preferably includes a torque monitoring component which provides an output so that the torque can be monitored and controlled. However, in an alternative embodiment, a torque sensor can be configured to monitor torque anywhere along the various drive components, including in the drive shafts.

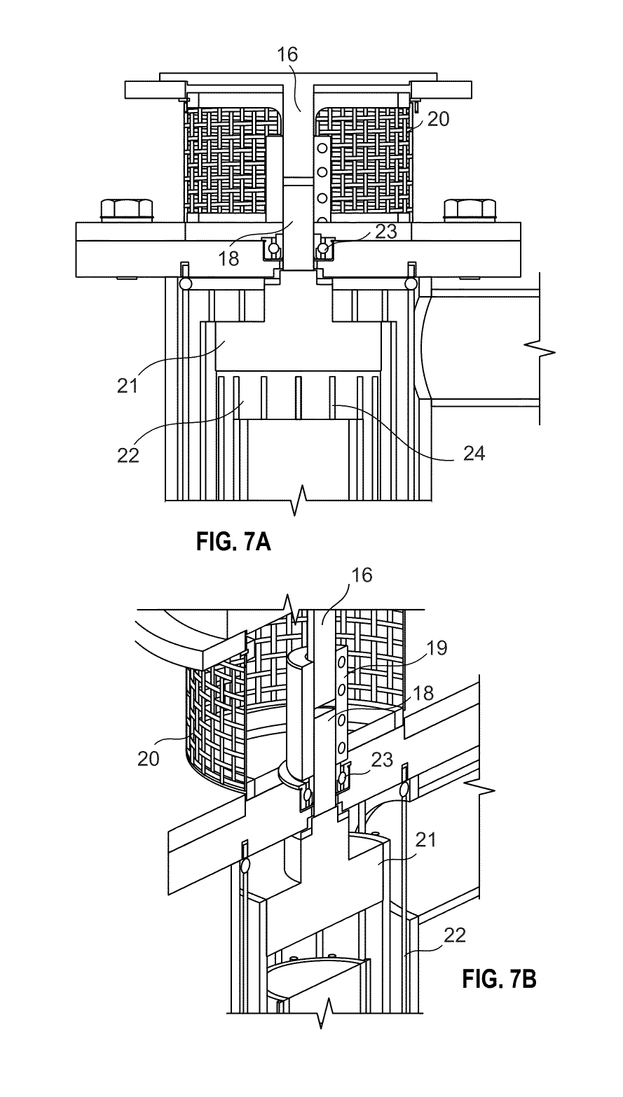

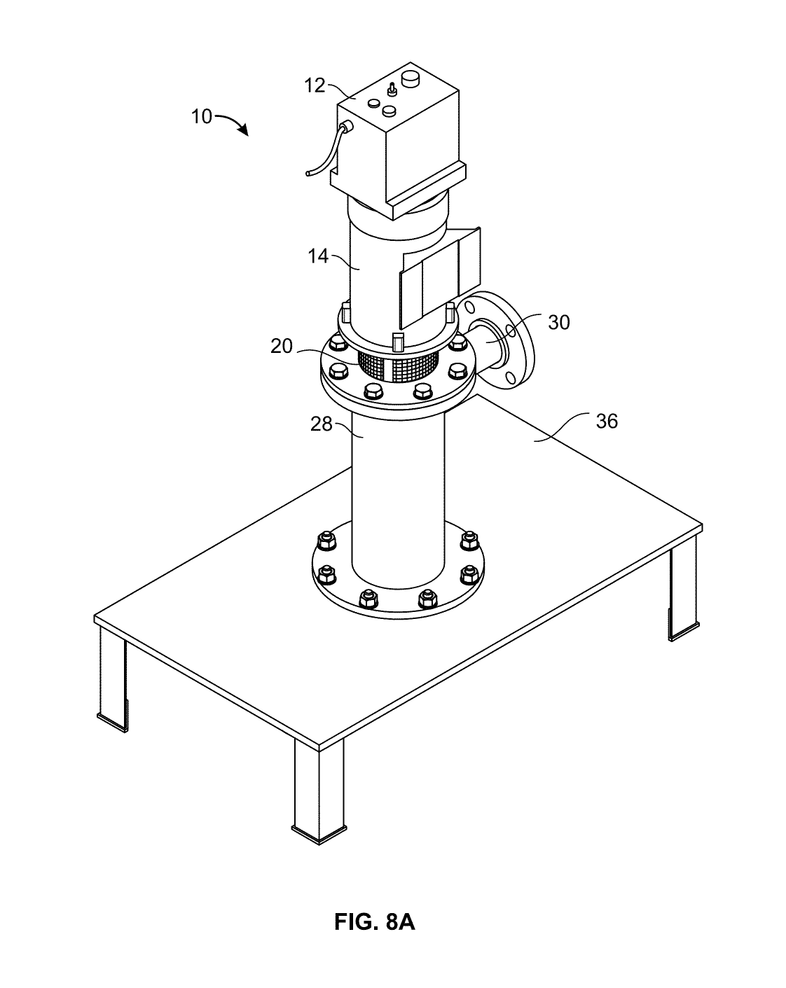

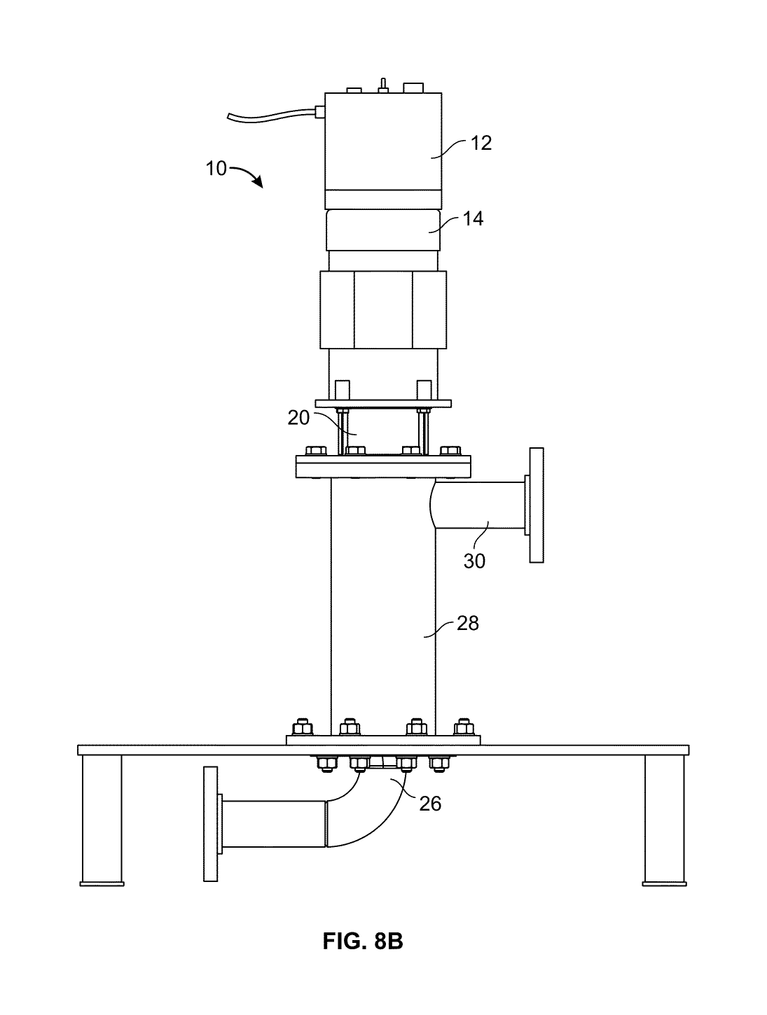

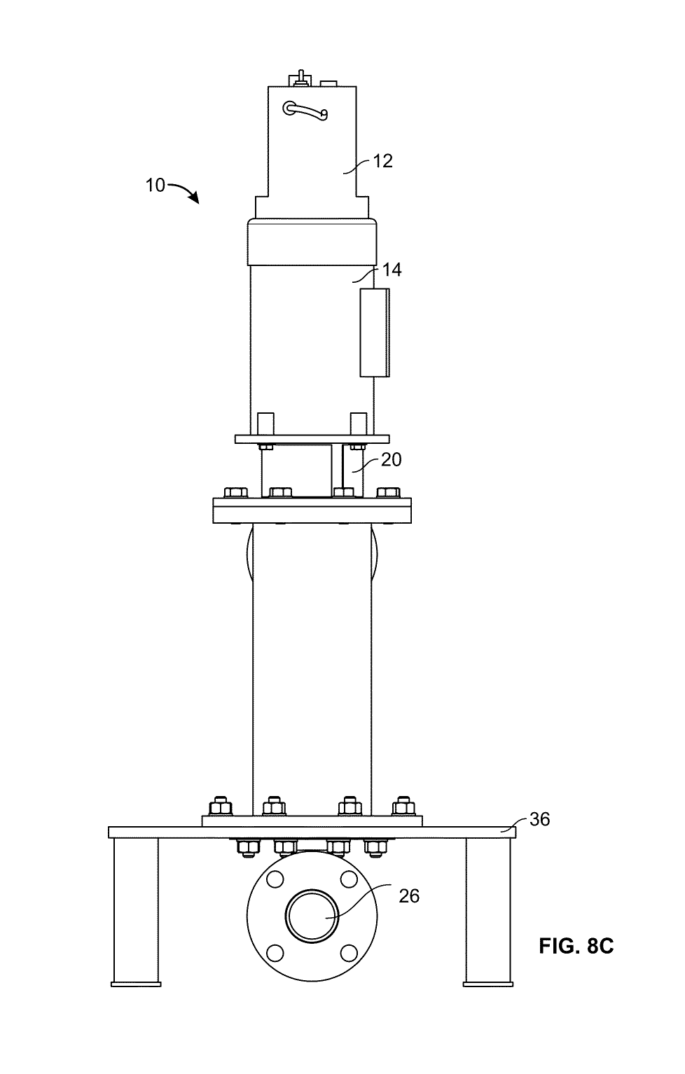

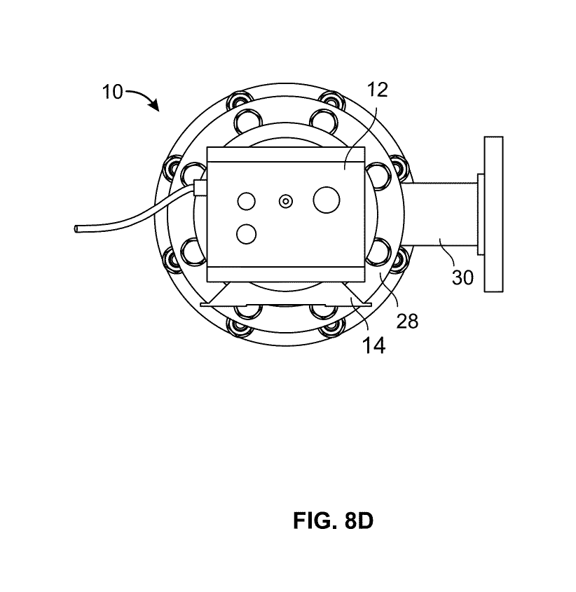

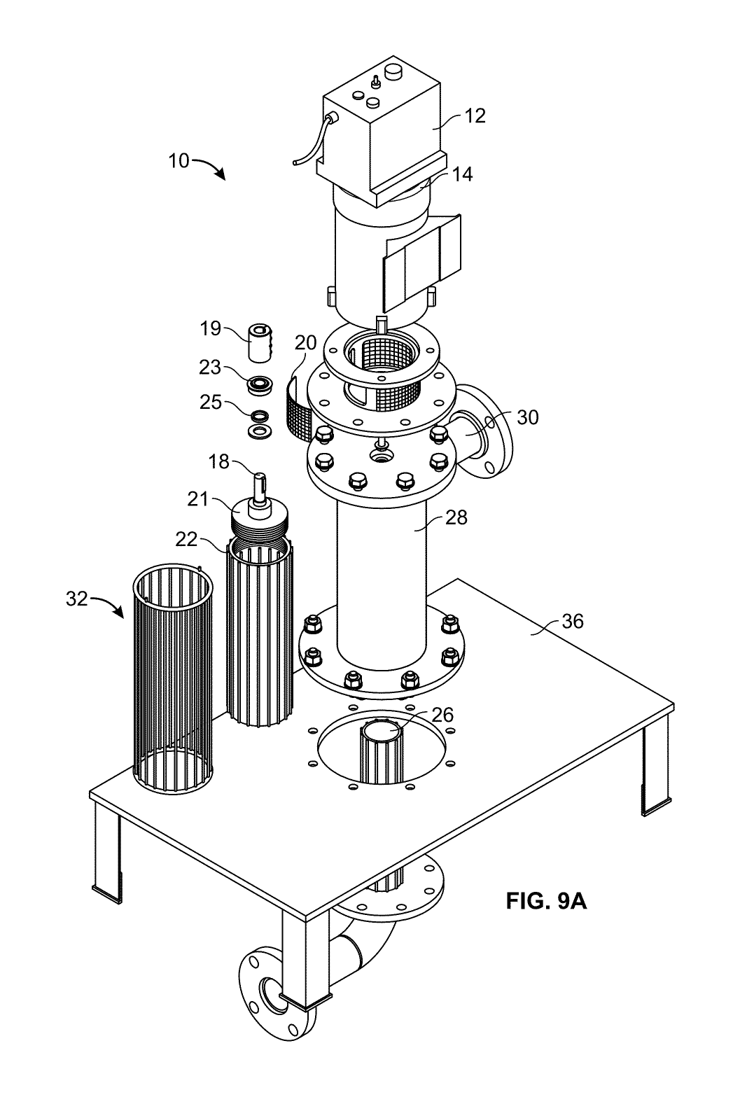

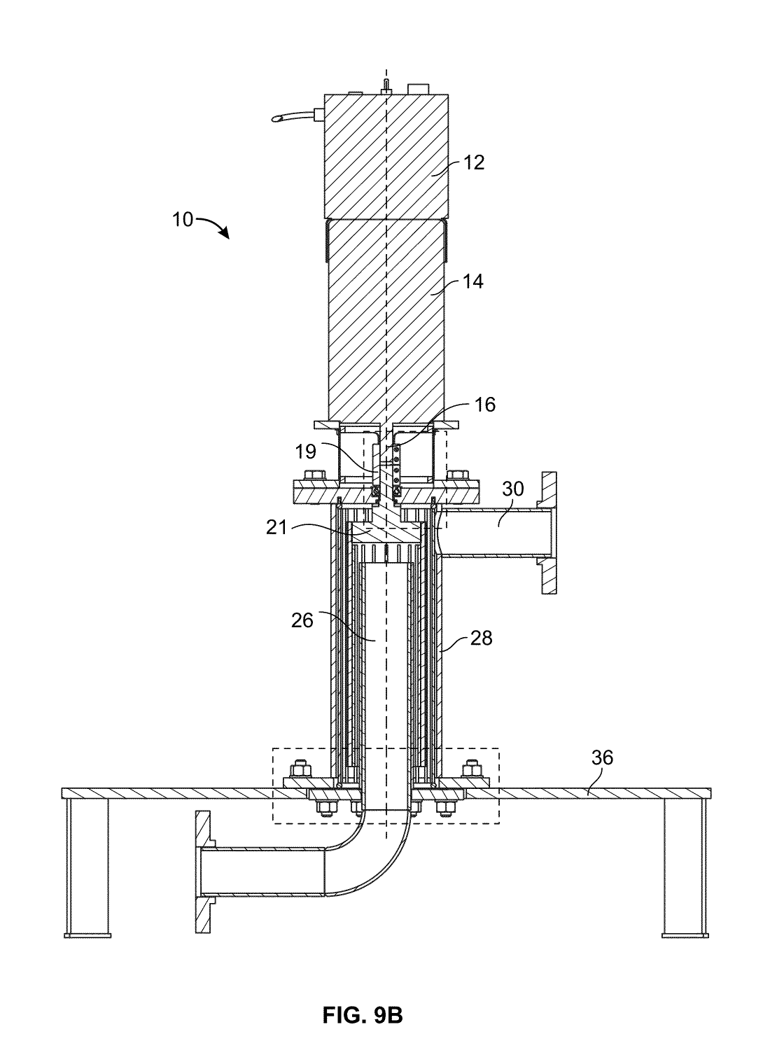

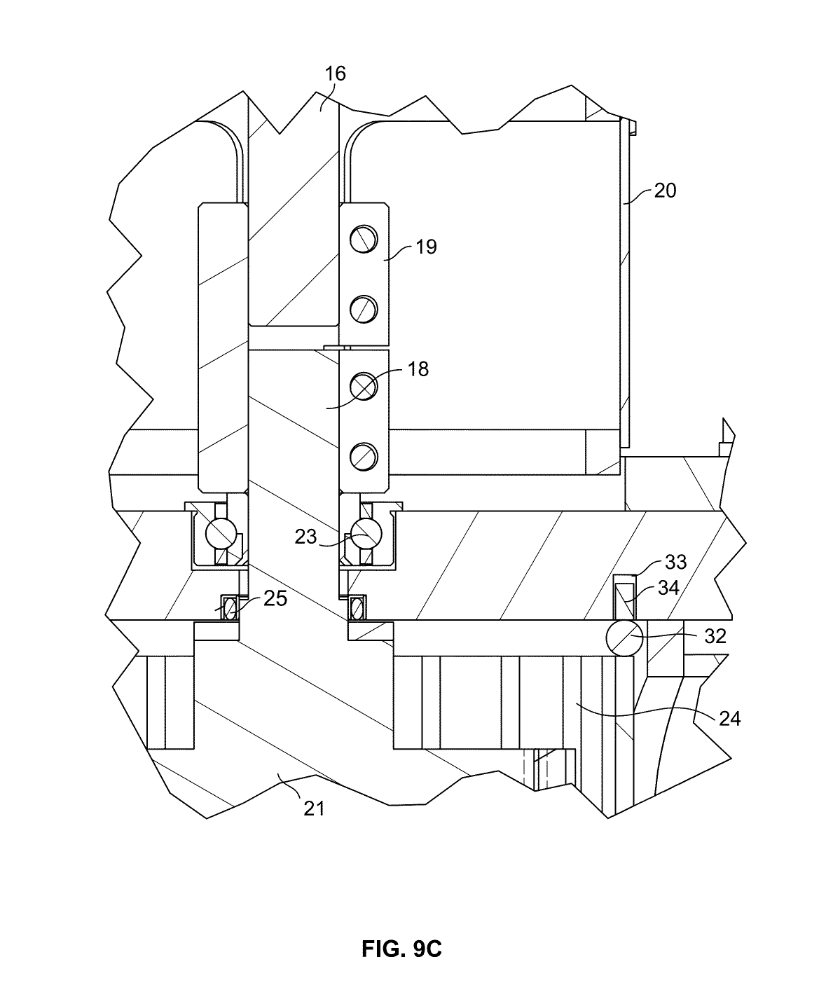

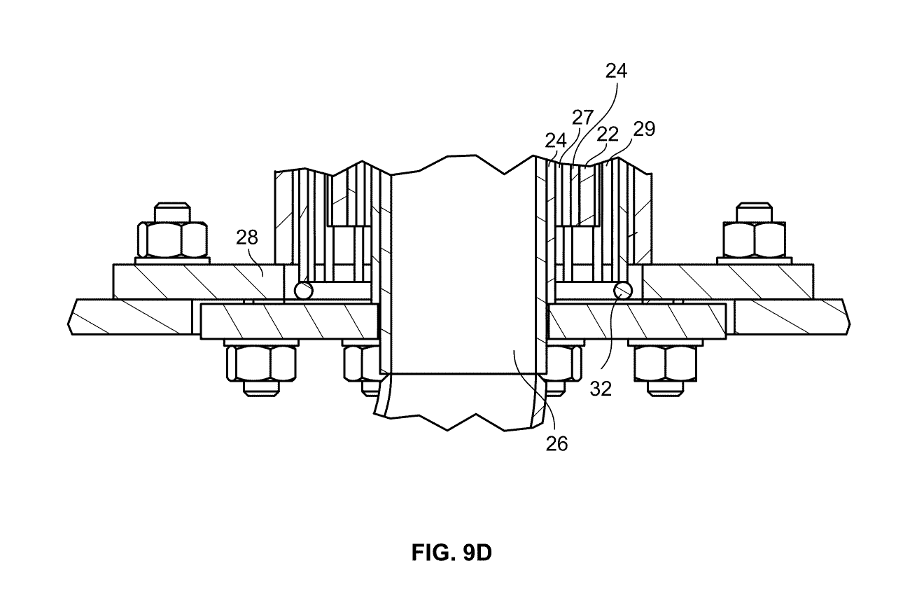

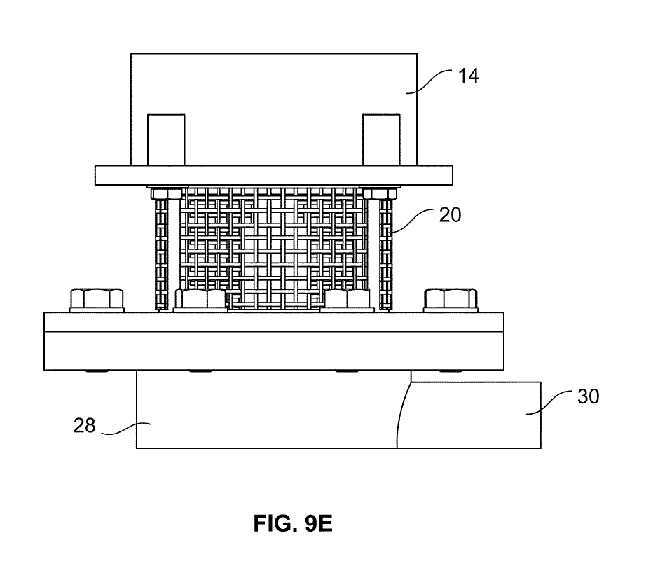

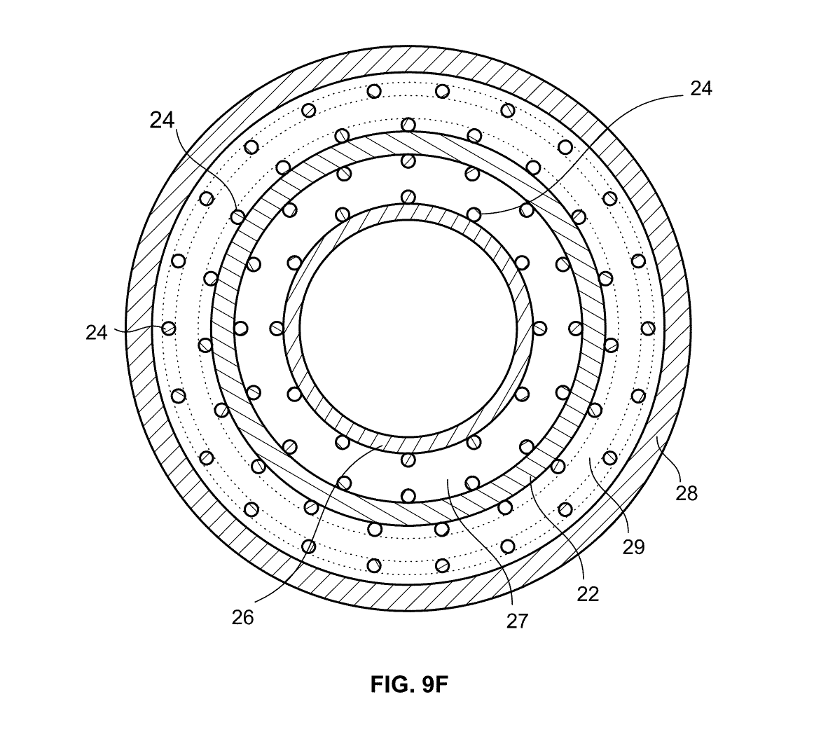

Although controller 12 is most preferably communicably coupled to variable speed drive unit 14 having a variable speed motor, in one embodiment, variable speed drive unit 14 can comprise a single speed motor. In this embodiment, controller 12 can instead control a transmission or other speed/torque adjusting mechanism (hereinafter generally referred to as an “adjustable transmission drive unit”) connected thereto. In yet a further embodiment, variable speed drive unit 14 can comprise a variable speed motor having an output connected to an adjustable transmission drive unit. In this embodiment, controller 12 can be configured to control aspects of both the variable speed motor and the adjustable transmission drive unit. In one embodiment, torque can be adjusted simply by adjusting the speed of variable speed drive unit 14. Variable speed drive unit 14 most preferably comprises output driveshaft 16 (see FIGS. 7A and 7B) which is preferably coupled to spindle driveshaft 18 via coupler 19. Because coupler 19 and shafts 16 and 18 rotate, guard 20 is preferably disposed around them to prevent accidental contact of the rotating components with foreign material. Optionally, guard 20 can be solid or perforated, such as a mesh material. Spindle driveshaft 18 is preferably coupled to or otherwise formed in connection with spindle cap 21. Spindle cap 21 is preferably communicably coupled to spindle 22. Bearing assembly 23 (see FIG. 9C) is preferably disposed around spindle driveshaft 18. Although bearings are most preferably used, desirable results can also be obtained with a bushing. Optionally, one or more structures 24 can be disposed on an inside and/or an outside of spindle 22. Structures 24 are preferably provided to create or otherwise enhance turbulence in fluid passing through inline mixer 10. Although structures 24 can comprise numerous shapes, sizes, patterns, numbers, and spacing, in one embodiment, structures 24 preferably comprise rods, vanes, and/or fins. Seal 25 is preferably disposed around spindle driveshaft 18 to prevent fluid that is being mixed from leaking out around shaft 18.

Spindle 22 is preferably disposed in the annulus formed between mixer inlet 26 and mixer housing 28. By so positioning spindle 22, fluid enters mixer 10, through inlet 26, the fluid then exits inlet 26 within a first annulus 27 formed between inlet 26 and an inside of spindle 22. Upon exiting inlet 26 within first annulus 27, the fluid is thus forced to reverse the direction of its flow and must travel back along the outside of inlet 26 until it exits first annulus 27. At that point, the fluid must again reverse the direction of its flow and travel through second annulus 29 formed between an outside of spindle 22 and an inside of housing 28 until it finally exits through outlet 30. The rotational force of spindle 22 induces mixing within first and second annuluses 27 and 29, to enhance the mixing effect to the fluid and to provide any desired shearing effect. Further, the addition of one or more structures 24, which thus project into annuluses 27 and/or 29 further enhance the mixing and shearing effects.

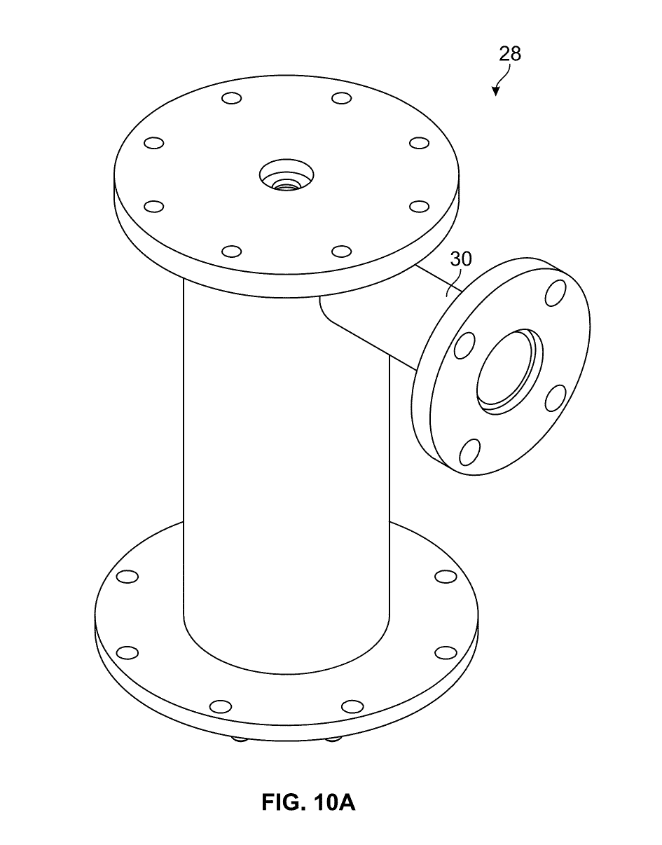

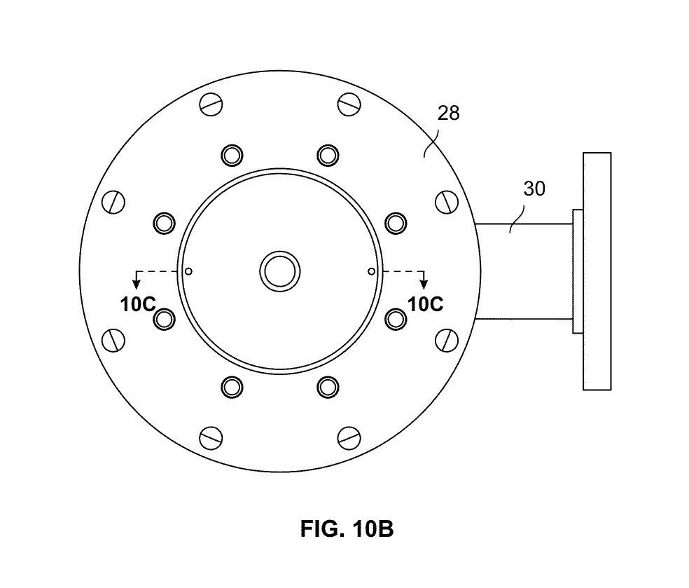

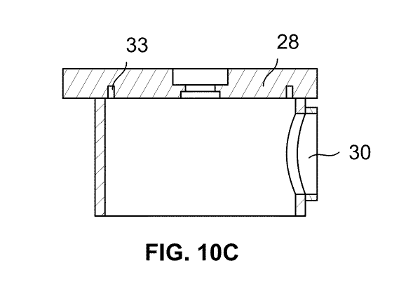

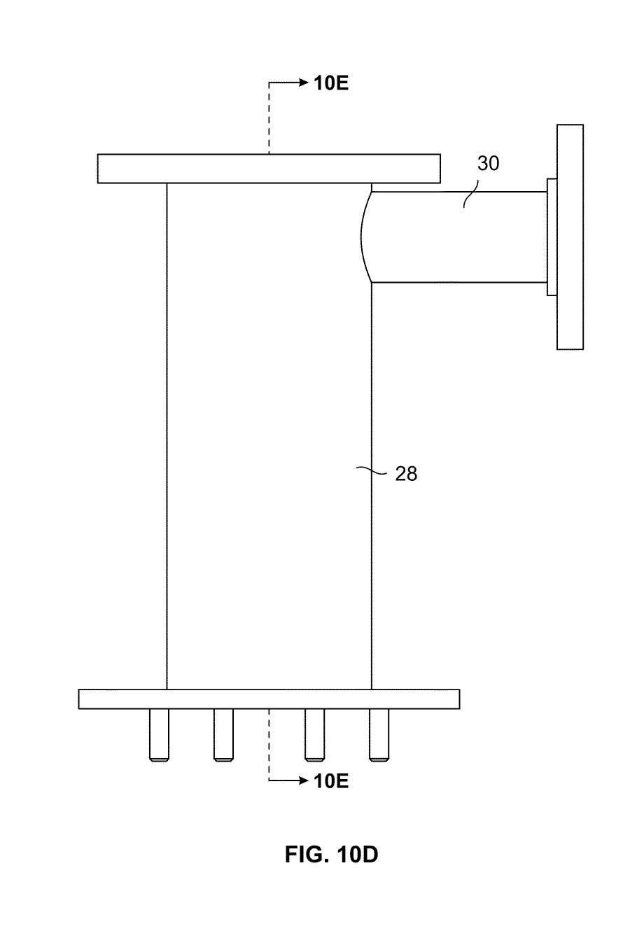

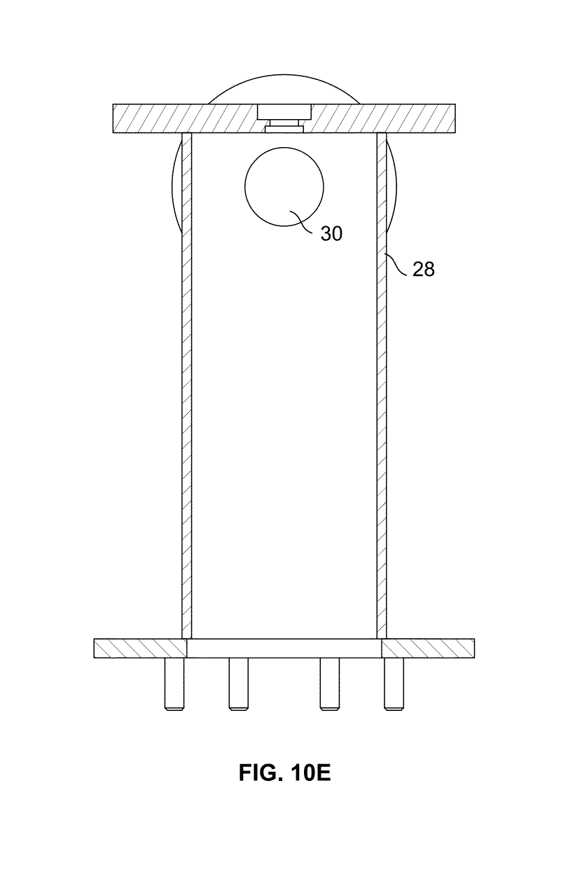

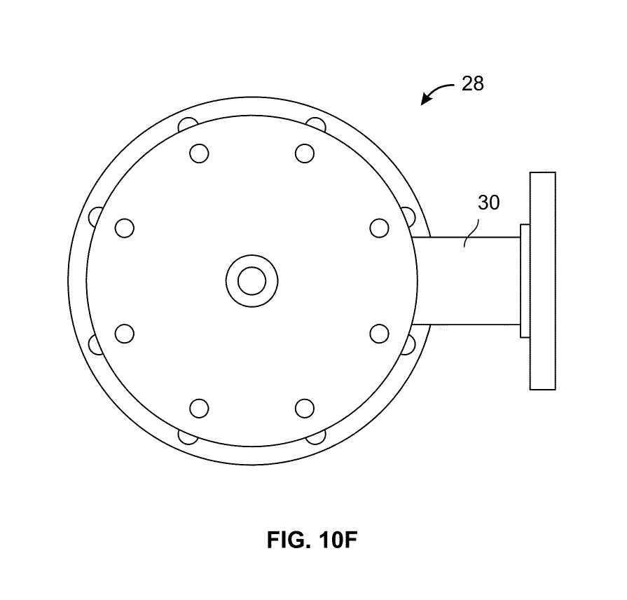

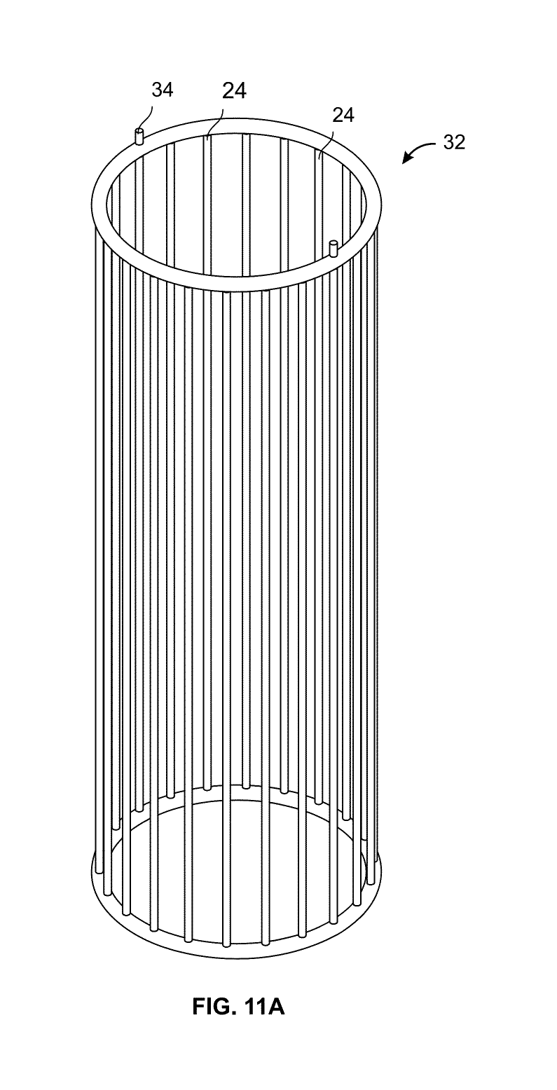

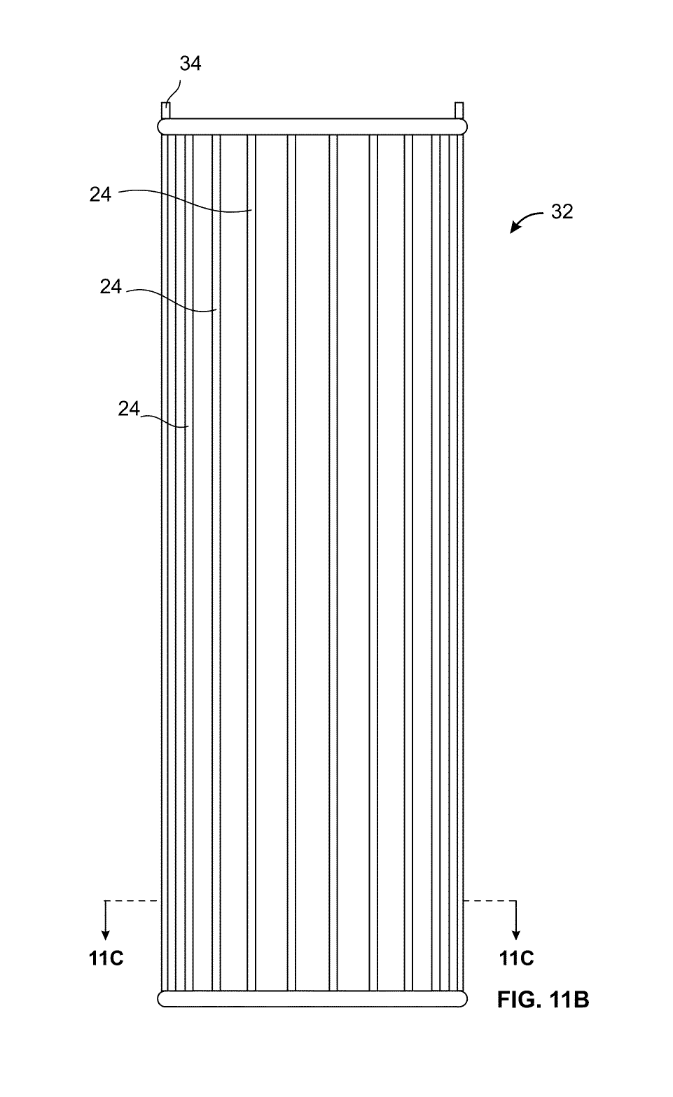

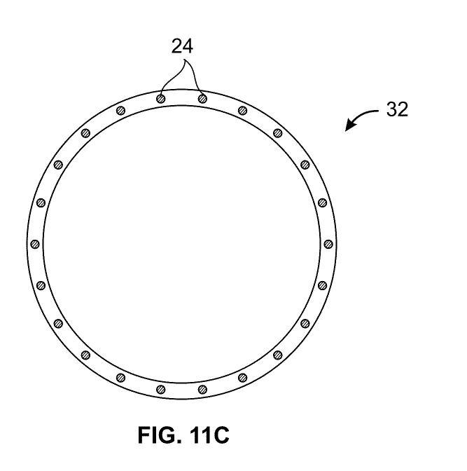

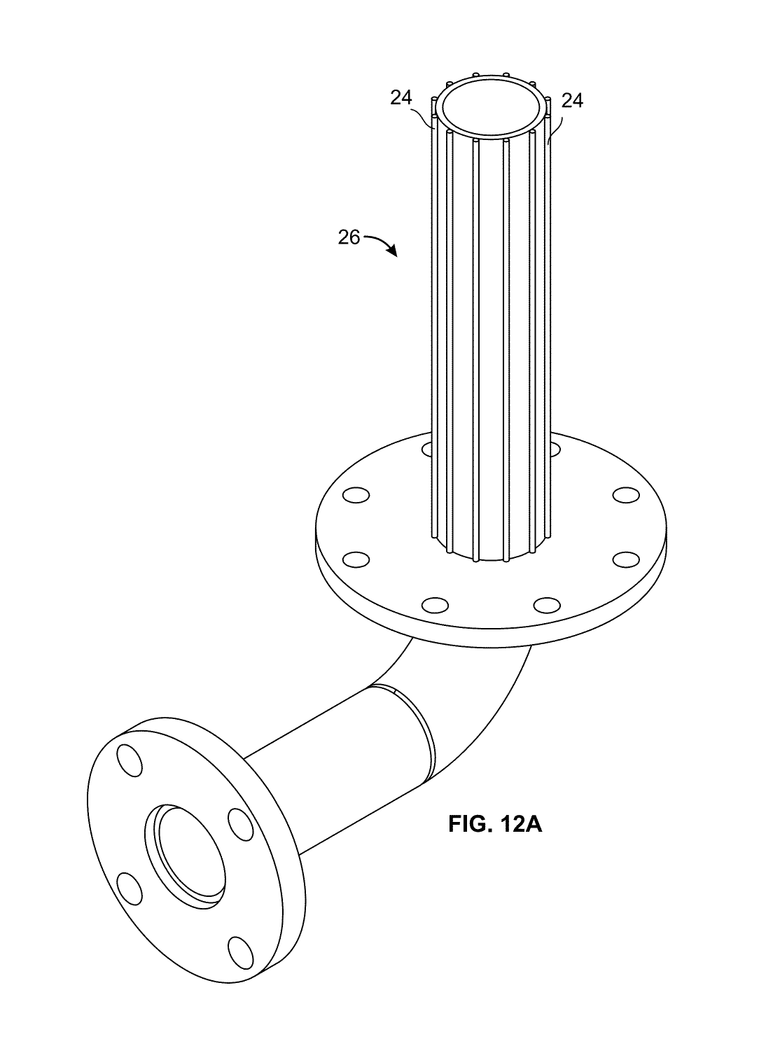

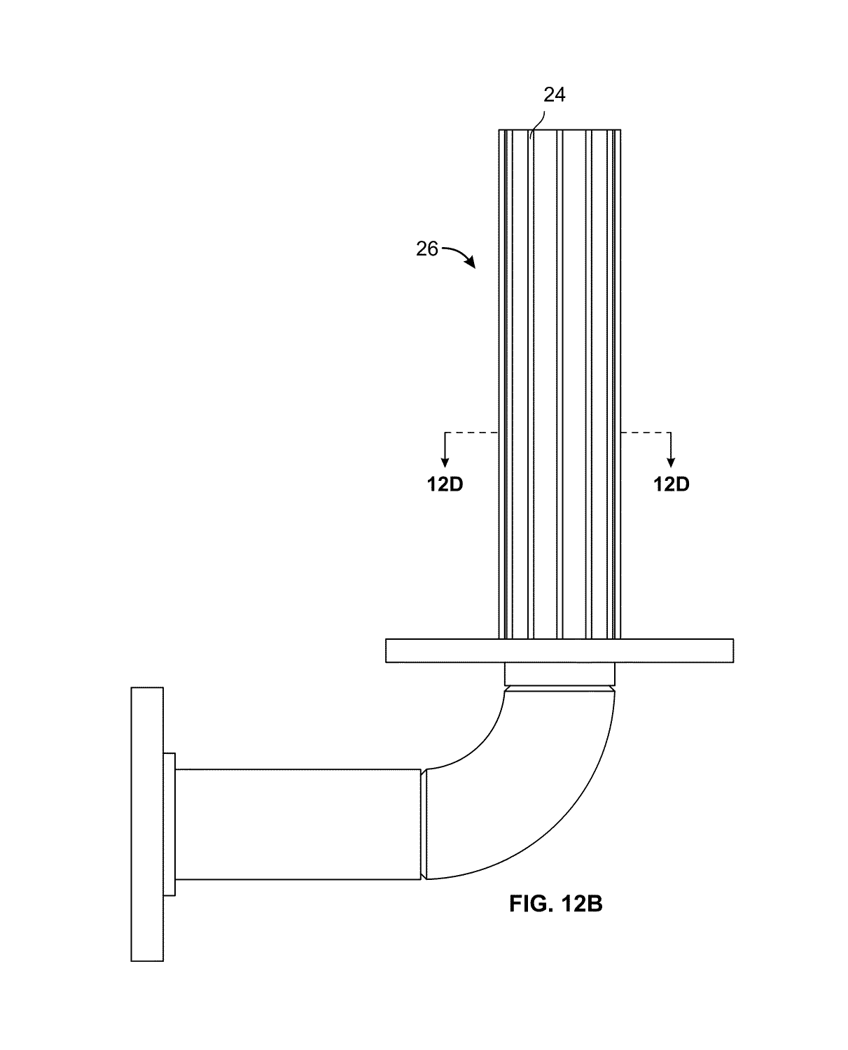

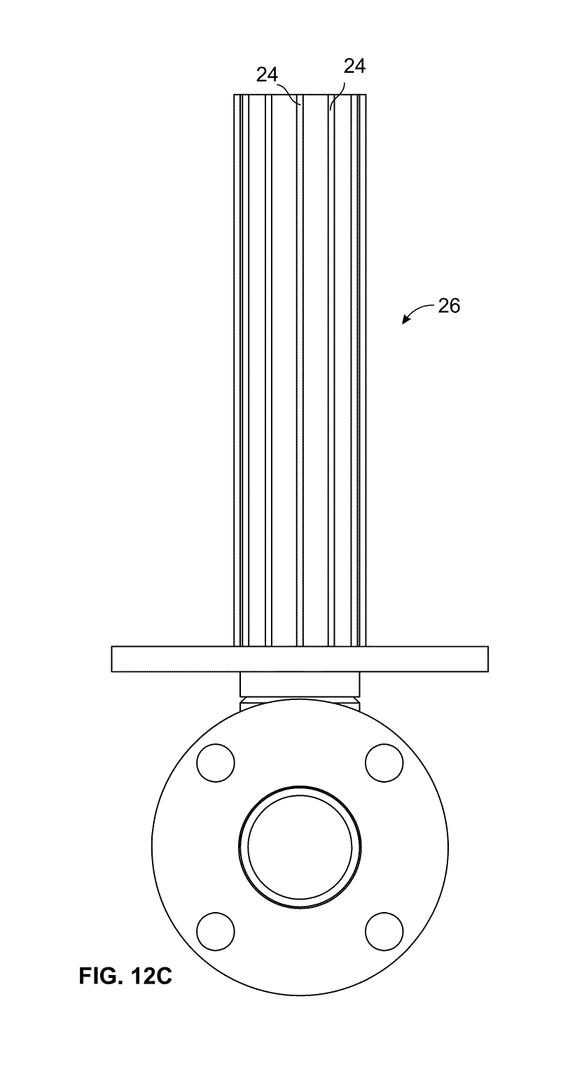

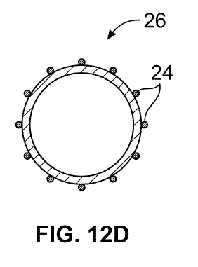

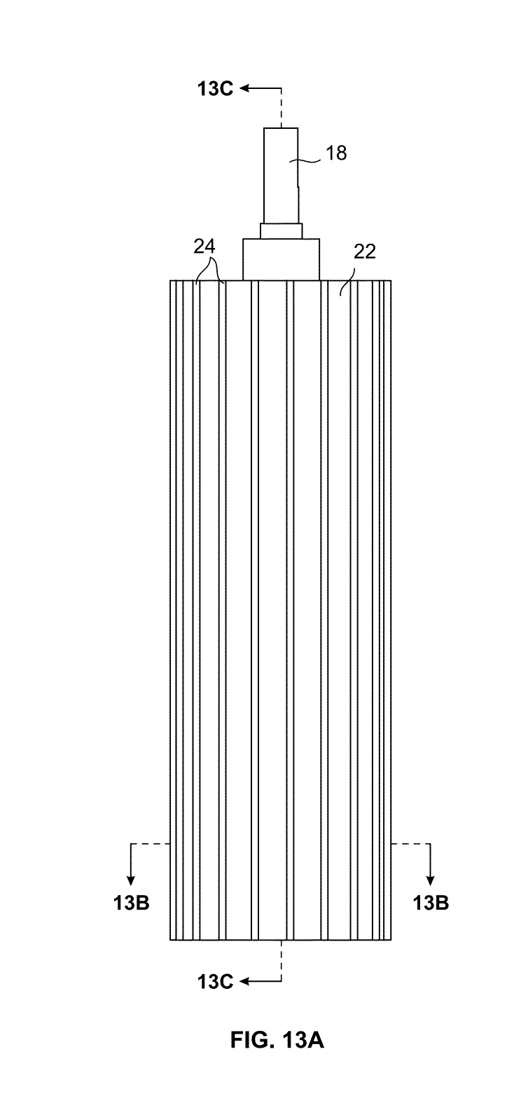

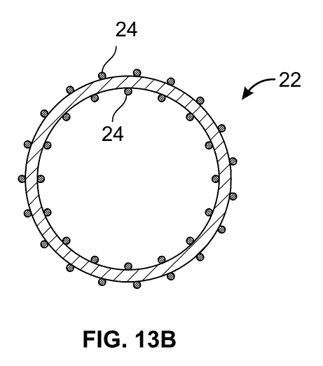

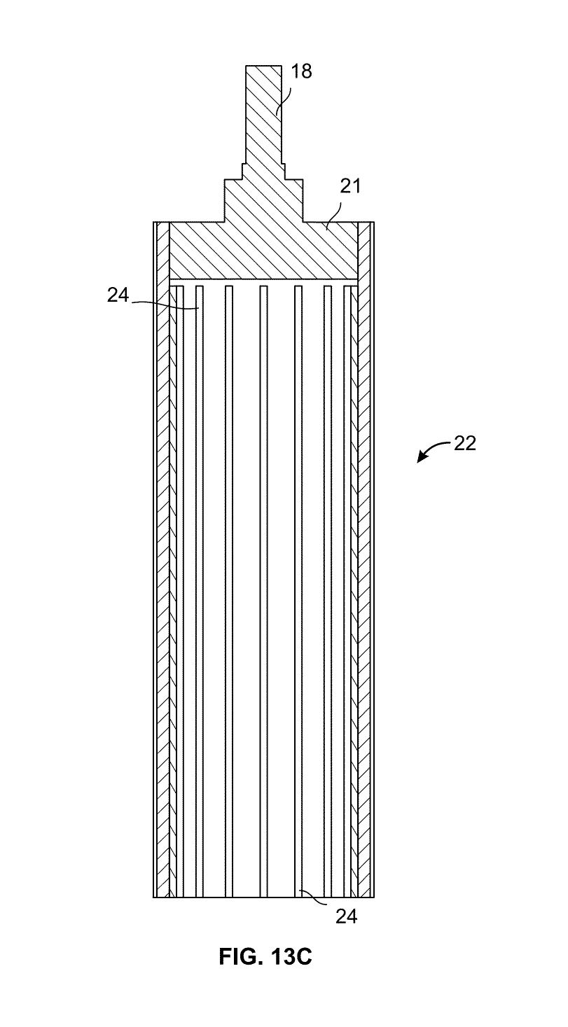

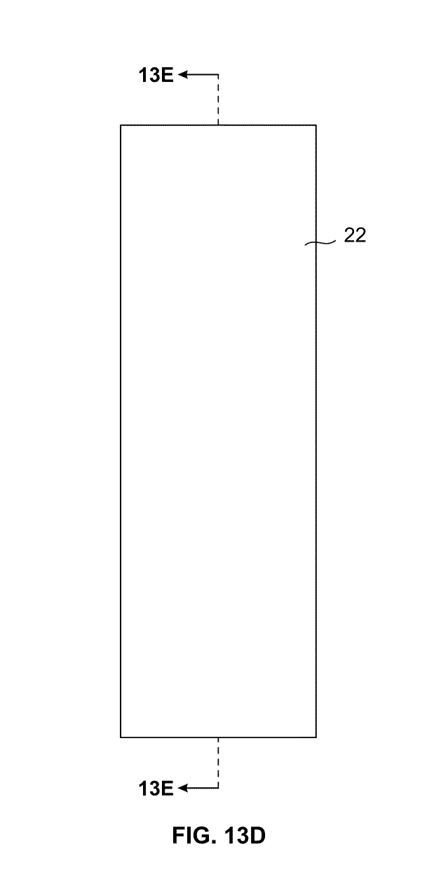

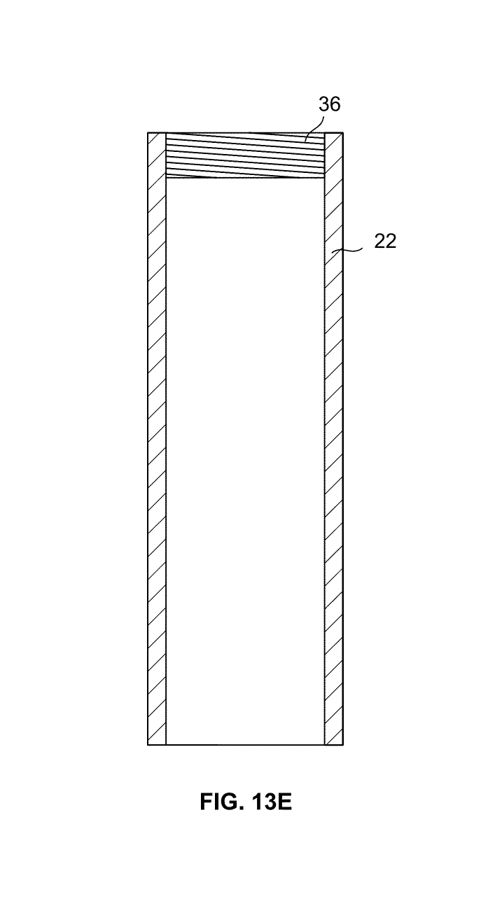

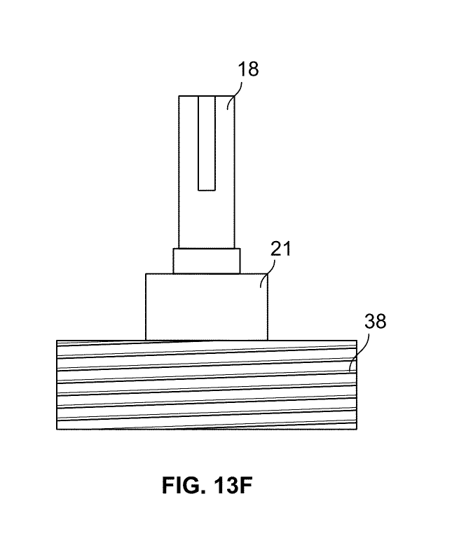

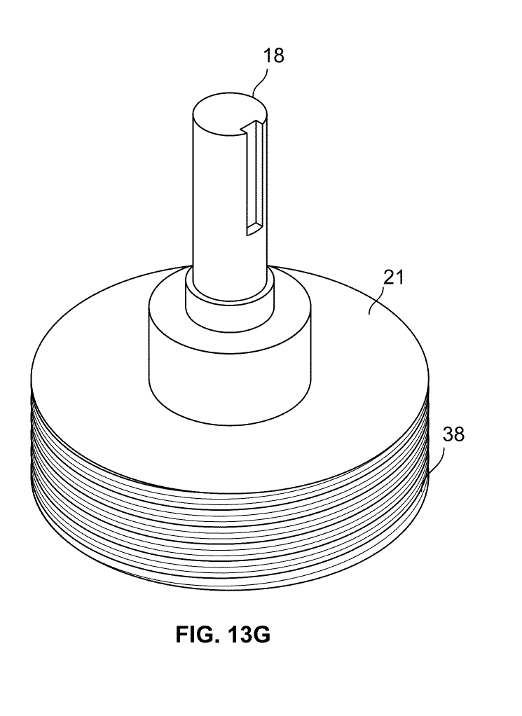

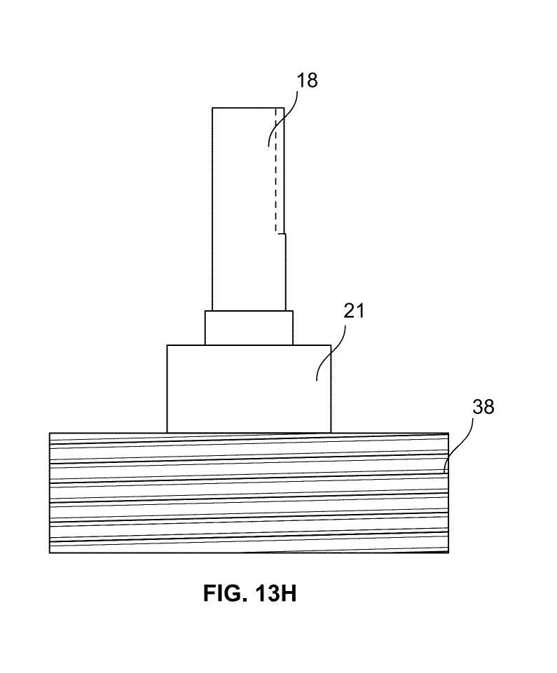

In one embodiment, structures 24 can easily be provided on an inside of housing 28 by connecting numerous structures 24 together to form cage 32 (see FIG. 11A). Cage 32 can then easily be slid into position within housing 28. Although numerous methods and fasteners can be used for securing cage 32 within housing 28 such that cage 32 does not begin to rotate with respect to housing 28, as could happen through rotational motion of the fluid against cage 28 due to the rotation imparted by spindle 22, in one embodiment one or more protrusions 34, are preferably disposed in an upper or lower portion of cage 32. Protrusions 34 are received within holes 33 (see FIG. 10C) that are drilled or otherwise formed into an upper or lower plate of housing 28.

In one embodiment, the present invention mixes the contents of only a single incoming stream. In an alternative embodiment, however, inlet 26 can be a divided structure having two openings on each end thereof such that two separated components are first brought into contact with one another within the inner portion of spindle 22.

In one embodiment, first and second annuluses 27 and 29 can be made to any desired width. In one embodiment, variable speed drive unit 14, housing 28, inlet 26, and outlet 30 can be produced with consistent dimensions and properties, thus providing a rather standard unit. In this embodiment, however, different cages 32 can be used to change mixing properties. Although cages 32 can be used to support structures 24 against an outer mixer surface, other mechanisms for providing structures 24 can be provided. For example, spindle 22 can have structures 24 attached or even formed directly onto one or more of its sides. Various spindles 22 can also be produced to change desired mixing characteristics. For example, one of spindles 22 can have a wall thickness which is rather large, for example a couple of inches, and can comprise structures 24 which are very short in height and have a rectangular cross section. In this embodiment, the thick wall of spindle 22 forces annuluses 27 and 29 to be exceedingly narrow and the shape and size of structures 24 result in exceedingly high sheer, even for liquids of lower viscosities. In this embodiment, providing spindles 22 of various wall thicknesses results in the ability for an operator to adjust the gap of each of annuluses 27 and 29. Optionally, spindle 22 can be changed or otherwise adjusted so as to change its length. For example, in one embodiment, a long spindle 22 can be removed from a mixer 10 and replaced with a shorter spindle 22 so that fluid passing through mixer 10 will encounter a much shorter time passing down and then back up past spindle 22, thus altering the mixing properties of mixer 10. In a further embodiment, the torque applied to spindle 22 can be adjusted by moving the spindle axially further into housing 28 or withdrawing it away from housing 28. Not only does this axial movement change the torque requirements, but it also adjusts the mixing properties of mixer 10. Different mixing properties can also be obtained by changing the diameter of the spindle coupled with the inner and outer annulus gap widths. Optionally, structures 24 that are disposed on any of the outer wall or inner wall of annulus 27 or the outer or inner wall of annulus 29 can be different shapes, sizes, and/or spacing from any of the other walls of the annuluses. In one embodiment, one or more of these inner and outer walls of annuluses 27 and/or 29 can be smooth and not comprise any structures 24.

In a further alternative embodiment, inner and/or outer portions of spindle 22 can be machined to a shape to provide desired mixing characteristics. For example, instead of cylindrical shape, spindle 22 can have a slightly conical shape wherein its top has a slightly smaller diameter than its bottom. In this embodiment, fluid passing through mixer 10 will encounter an annulus which continuously and gradually widens as it passes therethrough. Optionally, in addition to the conical shape of spindle 22, one or more of inlet 26 and/or housing 28 can also comprise a sloping shape such that the width of annuluses 27 and/or 29 have a consistent width. In this embodiment, spindle 22 can be moved axially to adjust the width of the annulus throughout the length of the side of the spindle. This embodiment can also provide the ability to adjust not only the torque, but also to change the shear rate and energy input.

As with the overall shape of spindle 22, structures 24, which can be machined thereon and which can be machined into the outer portion of inlet 26 or formed onto cage 32, can be milled or otherwise formed such that they also have a continuously or incrementally changing shape, size, pattern, and/or number. For example, in one embodiment, the shape, size, spacing, and/or number of structures can be formed such that mixer 10 is able to provide a gradually increasing or gradually decreasing shearing and/or effect as the fluid passes through it.

The shape and size of inlet 26 and even the shape and size of the inner portion of housing 28 can also be formed to provide desirable shapes and widths to annuluses 27 and 29. In an alternative embodiment, cage 32 can also comprise a solid-walled structure which has structures 24 formed or otherwise disposed on an inside diameter thereof. In this embodiment, the thickness of the solid walled-portion of cage 32 itself can be used to adjust the width of second annulus 29.

Although the drawings of this application illustrate structures 24 as being elongated and substantially aligned with a primary axis of spindle 22, it is important to note that structures 24 are not limited to such shapes and configurations. Rather, structures 24 can comprise any shape, structure, and orientation. For example in one embodiment, structures 24 can be elongated and spiraled. In this embodiment, such spiraled structures 24, when disposed on spindle 22 can be arranged to assist in moving the fluid through mixer 10 or they can be arranged in a direction which is counter to that of the rotational direction of spindle 22 such that they work against the flow of fluid traveling through mixer 10.

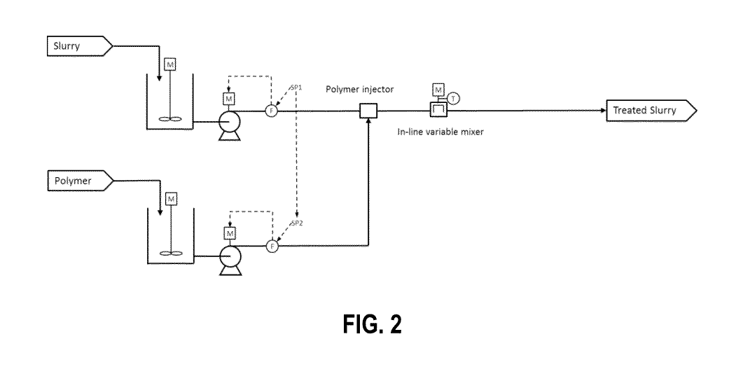

In one embodiment, supporting structure, 36, which can include a support bench or which can comprise skids, is preferably provided. In a preferred embodiment, mixer 10 is preferably positioned such that the primary axis of drive shafts 16 and 18 are orientated substantially vertically. However, desirable results can also be achieved when mixer 10 is positioned in other orientations. For example, in one embodiment, mixer 10 can be laid out in a substantially horizontal configuration such that a primary axis of drive shafts 16 and 18 are substantially horizontal. In a further embodiment, although the foregoing text and the drawings of this application describe and illustrate the input as being at the lower end of mixer 10 and the output as being on a side of housing 28, desirable results can also be achieved if the fluid is pumped through mixer 10 in the opposite direction (i.e., forcing the fluid into outlet 30 and allowing it to exit mixer 10 through what is labeled as “inlet 26” in the drawings).
1) FIG. 2 illustrates an inline flocculation process installation according to an embodiment of the present invention. As illustrated therein, the slurry feed flow rate is preferably controlled to an operator specified flow rate (SP1);
2) The polymer or other solid feed flow rate is preferably adjusted based on a value that is dependent on the target polymer dosage, the slurry feed flow rate and the slurry solids mass concentration (SP2);
3) The polymer or other solid can be introduced into the slurry pipeline via an injector, which can be any known injector capable of injecting the polymer. However, desirable results can also be obtained by any other manner known for disposing the polymer or other solid into the slurry pipeline; and
4) An inline variable mixer, according to an embodiment of the present invention is then preferably used to properly mix the slurry.

In one embodiment, mixer 10 can be controlled through one of the following alternatives:

Alternative 1.
A) Periodically (e.g., every 10 minutes or other predetermined time), an optimization algorithm measures the spindle torque as a function of spindle speed to establish the current torque response curve (which is a function of the slurry properties, polymer or other solid properties and dosage, feed solids mass concentration, reactor retention time, degree of feed conversion, temperature and pressure).
B) Based on the torque response curve, the optimum rotational speed is identified and the mixer set to operate at this speed.
C) Step A is then repeated.

Alternative 2.
A) The optimization algorithm changes the spindle speed by a small increment, AR.
B) If the spindle torque remains the same or otherwise increases, no action is taken.
C) If the spindle torque decreases, then the spindle speed is increased back to that from the prior step.
D) The optimization algorithm waits for a defined time period (e.g., 2 seconds or other predetermined time) and then Step A is repeated.
E) Optionally, additional mixing can be provided downstream of inline mixer 10. This can be achieved using the piping downstream of the inline mixer. The piping can optionally incorporate static mixers to reduce the pipe length required to achieve the mixing.

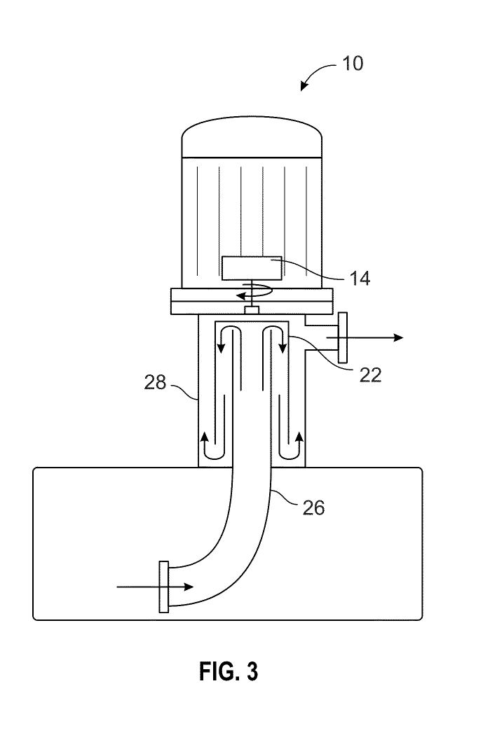

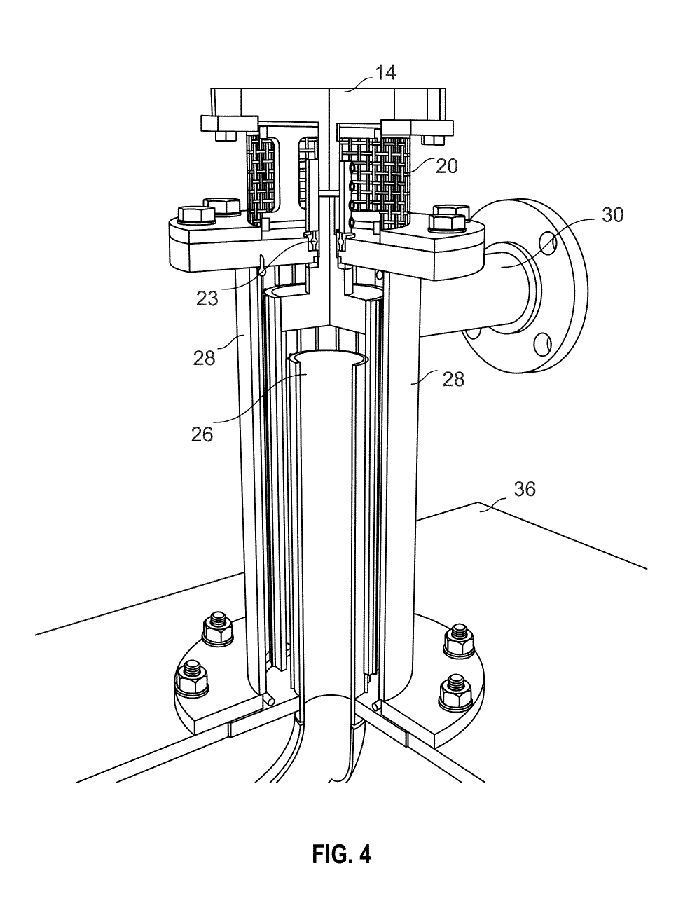

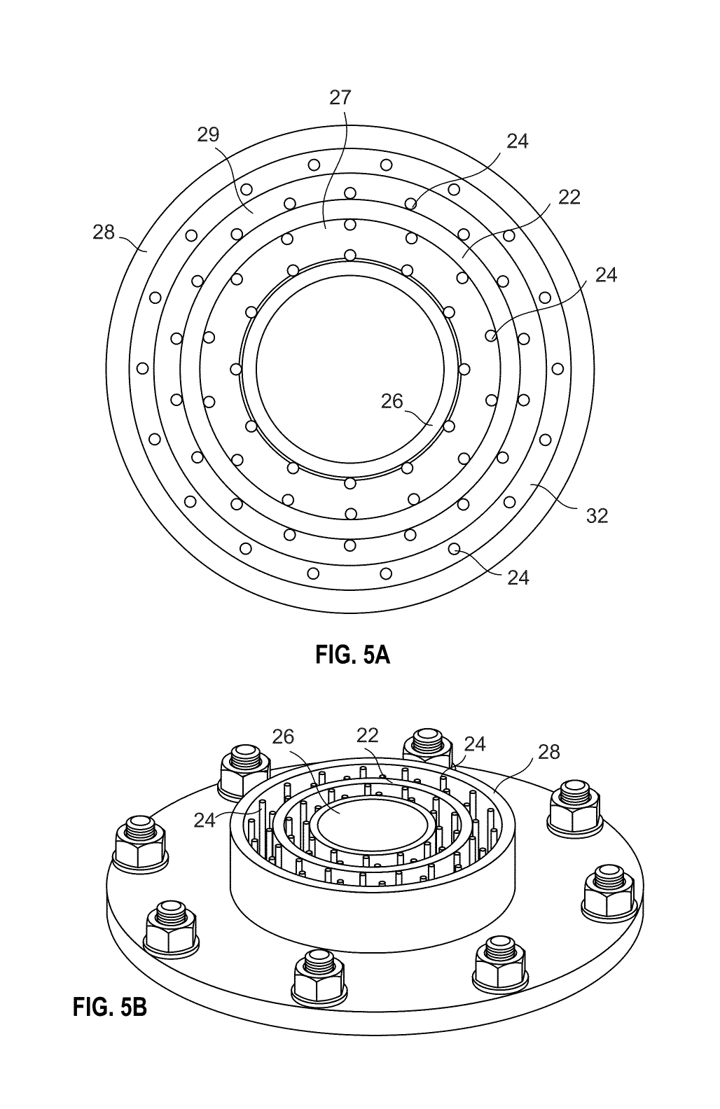

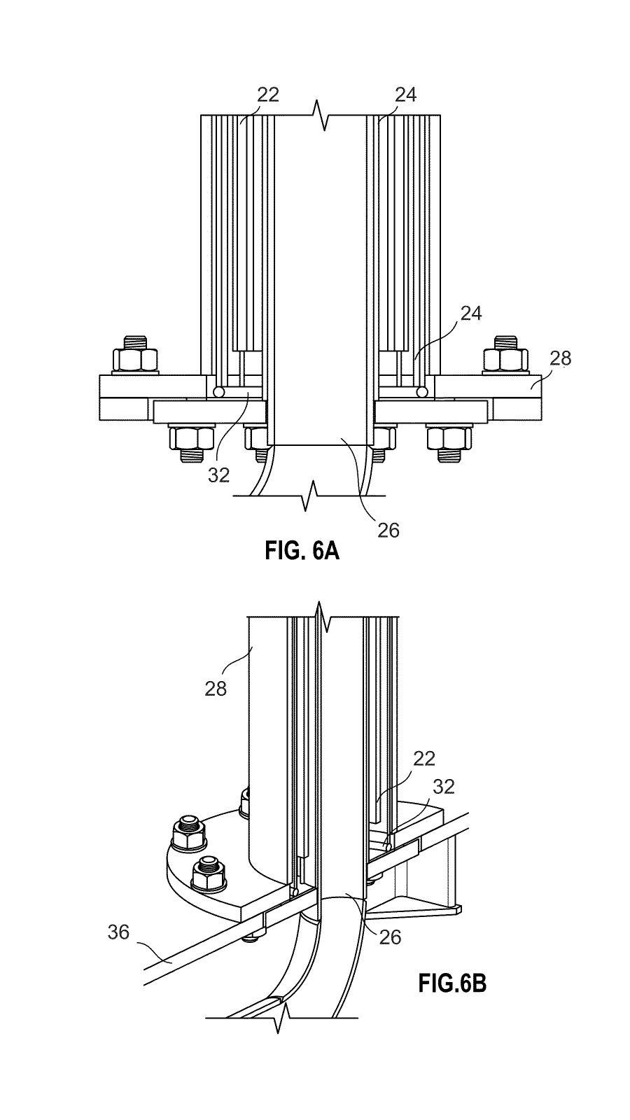

FIG. 3 illustrates an embodiment of mixer 10 mounted on bench 36. In this embodiment, the liquid to be mixed is preferably fed into a rotating cylinder/spindle, and travel of the slurry is preferably in the manner illustrated by direction of the arrows. In one embodiment, multiple different cages 32 can be provided, each comprising structures 24 of various shapes, sizes, and spacing. With multiple different cages, a user can easily adjust mixing characteristics by simply removing the old cage and dropping in a new one. Structures 24 can comprise fluted or machined grooves, welded rods, or other shaped components. Optionally, spindle 22 can be formed from an extrusion wherein structures 24 are integrally formed on an inside, outside or a combination of inside and outside of spindle 22. In one embodiment, cage 32 can be formed from structures 24 which are about 3 mm diameter rods that are spaced apart by about a ½″ inside gap.

Although dimensions are illustrated in FIG. 15, the invention is not limited to those particular dimensions. Variations, known to those skilled in the art, may also be utilized in the present invention.

In one embodiment, mixer is not connected to a tank for batch mixing. In another embodiment, mixer comprises a flocculant slurry mixer.

### INDUSTRIAL APPLICABILITY

The invention is further illustrated by the following non-limiting examples.

### EXAMPLE 1

A mixer was constructed according to an embodiment of the present invention;

### Control System For Inline Flocculation Applications

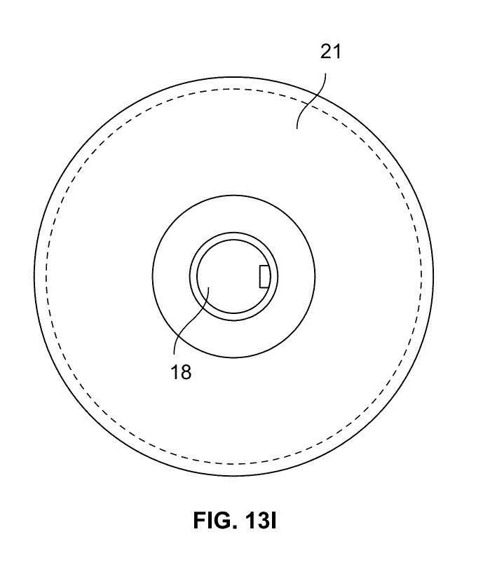

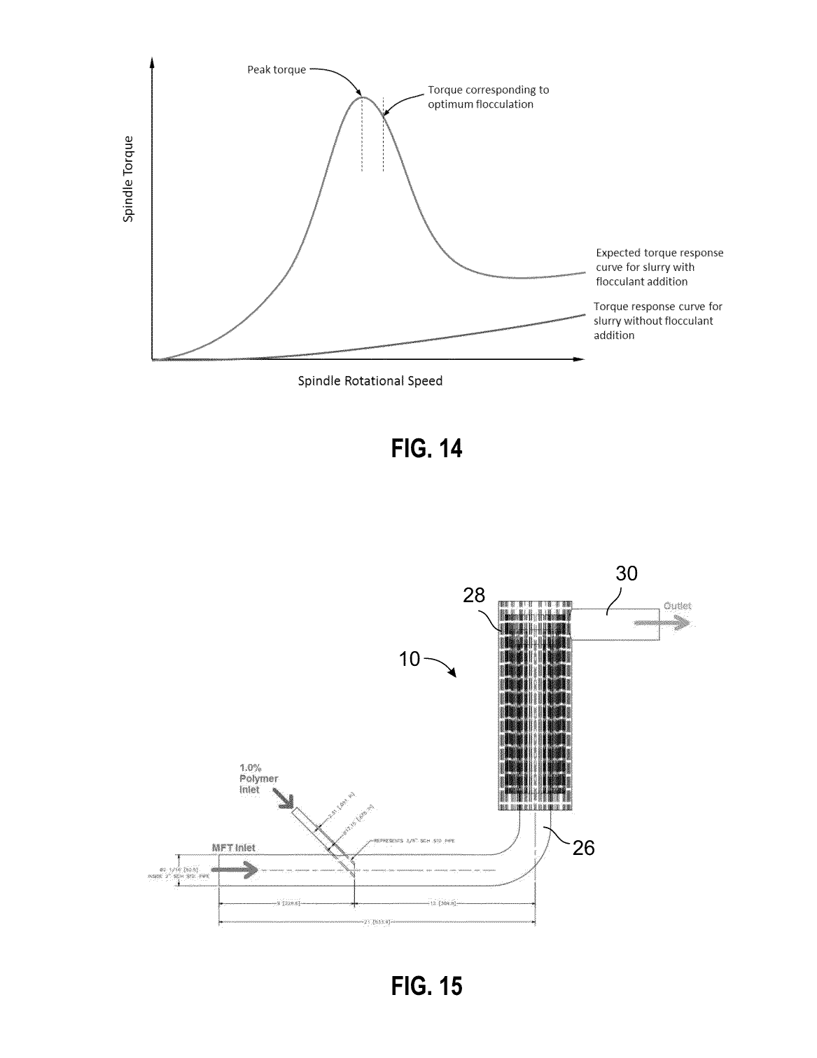

Using an apparatus according to an embodiment of the present invention; with reference to FIG. 14:

The lower curve presents the expected torque response curve for slurry only without flocculant addition. The spindle torque increases with increased rotational speed as the friction losses are proportional to rotational speed.

The bell curve shows the variation in spindle torque with spindle rotational speed for a slurry with flocculant added:
A) With increased rotational speed, the torque increases until a peak torque value is reached. Increasing the spindle rotational speed in that region results in more effective flocculation due to additional mixing of the slurry and flocculant. The structures created by the flocculation process increased the mixture rheology which in turn increased spindle torque.
B) Increasing the rotational speed beyond the peak value results in partial break-down of the flocculation structures with consequent reduction in rheology and spindle torque.
C) Very high spindle speeds cause almost complete break-down of the flocculation structures. In that region, the spindle torque again increases with increasing rotational speed due to increased friction at higher speeds.
D) Testing indicates that typically optimum flocculation (in terms of dewatering performance) is achieved at a point just beyond the maximum rheology value (corresponding to the peak torque value).

### Computational Fluid Dynamics (CFD) Analysis

Computational fluid dynamics (CFD) analysis of the inline mixer of the present invention was done to show the variability of mixing efficiency and energy shearing input achieved by changing rotational speed. A multiphase, non-Newtonian CFD analysis was completed.

### Model Inputs

The boundary conditions are outlined in Table I (see below) and material properties in

Table II (also below). Mature fine tailings (MFT) were input in the large pipe and polymer solution was input into the smaller pipe as illustrated in FIG. 15.

TABLE I
Important Model Inputs and Boundary Conditions

| Item | Value/Description | Comments |
|---|---|---|
| MFT Velocity | 0.5 m/s | Bingham Plastic |
| Polymer Solution Velocity | 1.07 m/s | Power Law Fluid |
| Pipe Internal Diameter | two inches | All Simulations |

TABLE II
Measured Rheology at 21.5° C.

| | | Bingham | Flow | Plastic |
|---|---|---|---|---|
| | | Yield | Behavior | Viscosity |
| Item | Slurry Density | Stress | Index (n) | (k) |
| 30% m MFT | 1227 kg/m³ | 0.360 Pa | — | 0.00692 Pa · s |
| 1.0% m | 1006 kg/m³ | — | 0.431 | 2.780 Pa · s |
| Polymer | | | | |

### CFD Results

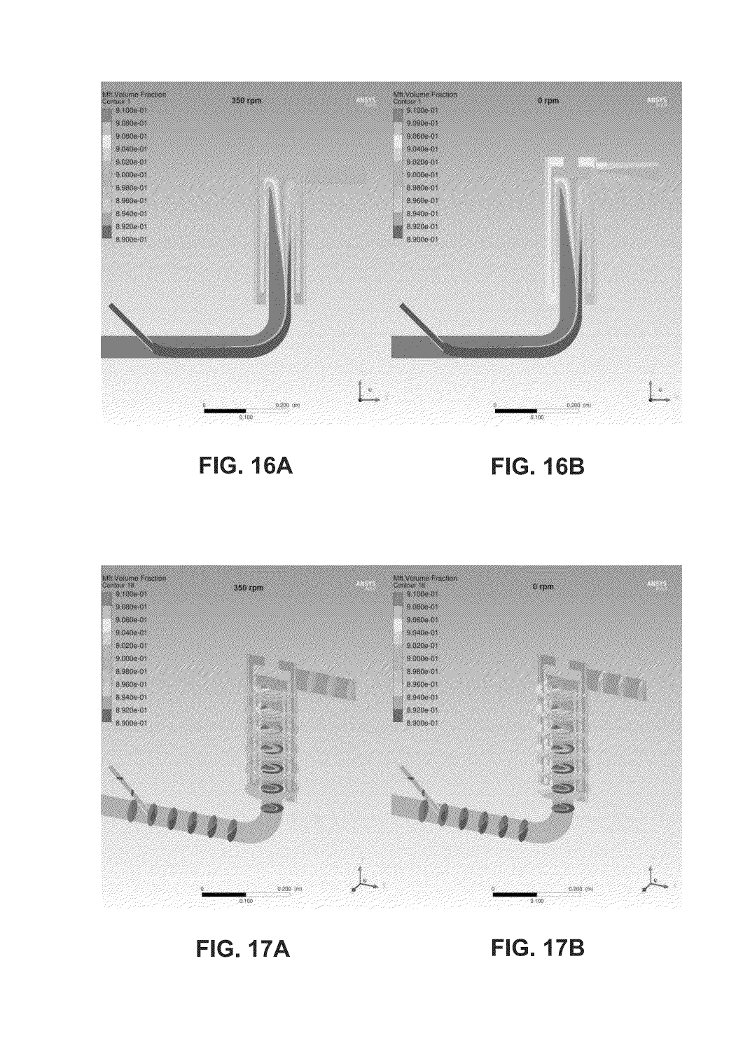

CFD simulation results for the maximum rotational speed (350 rpm) (FIG. 16A and 17A) and minimum rotational speed (0 rpm) (FIG. 16B and 17B) for the inline variable mixer were performed. As can be seen in the figures, the amount of mixing in the pipe was identical until it reached the spinning cup and the flow direction reversed. As the flow was travelling down the inside of the cup, the 350 rpm simulation achieved much higher mixing.

### Mixing Comparison

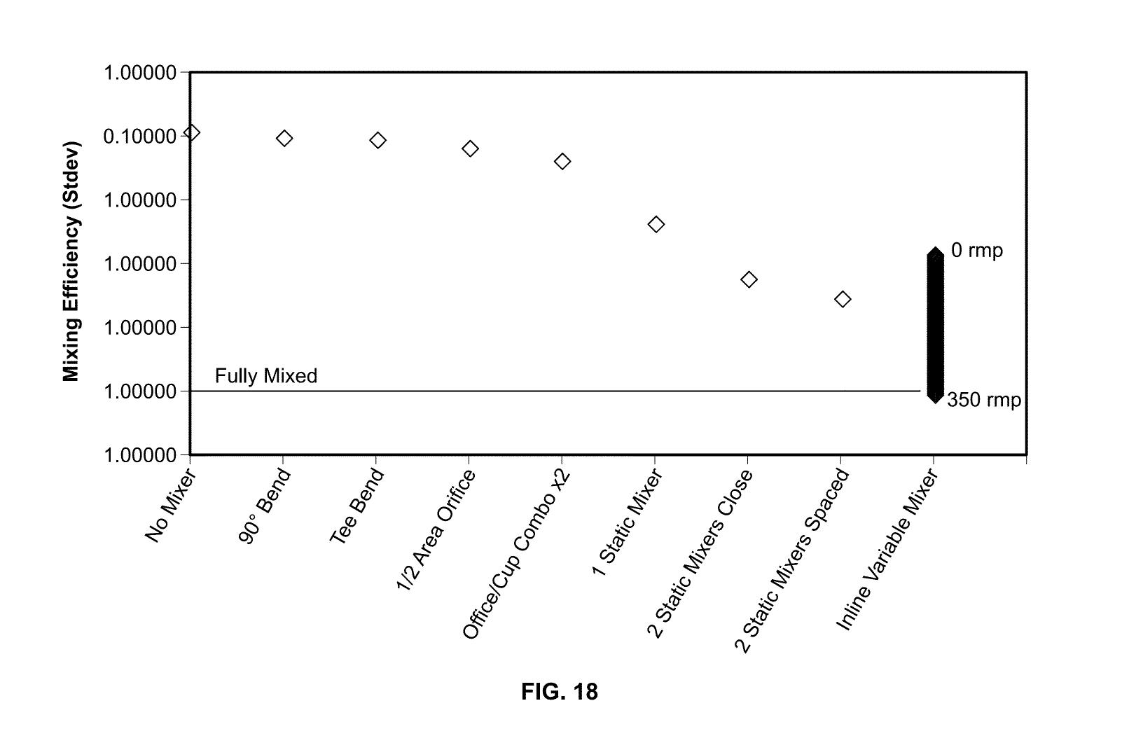

FIG. 18 gives a comparison of the efficiency of all mixing arrangements investigated for the MFT and polymer solution flow. With the setup modeled for the inline variable mixer, zero rpm corresponded to more than the amount of mixing achieved by one static mixer, but less than two. With the inline variable mixer spinning at the maximum rate, more than one order of magnitude better mixing was achieved than was achieved with two static mixers. The inline variable mixer was able to get a mixing variability of about two orders of magnitude. The mixing efficiency range can be adjusted by modifying and optimizing the inline mixer configuration.

### Shearing Energy Input

Equations (1) and (2) are used to determine the shearing energy input by the inline variable mixer:

$$P = \frac{2 * π * N * T}{60} = Δ P * Q \qquad Equation ( 1 )$$

where: P=power absorbed (W or N.m/s or kg.m²/s³)
N=device rotational speed (rpm)
T=rotor shaft torque (N.m)
ΔP=change in pressure (Pa or N/m² or kg/m.s²)
Q=flow rate (m³/s).

### Equation (2)

$$E = \frac{P}{Q} = Δ P$$

where: E=absorbed energy per unit volume (J/m³ or N/m² or kg/m.s²).

It was found that for the configuration investigated a single inline variable mixer can vary the shearing energy input into the slurry by an equivalent of between 2 and 23 static mixers by changing rotational speeds.

### Assumptions and Simplifications

The following assumptions and simplifications were made to the model:

1) Structures 24 were modeled with a square cross section; and 2) Any effects caused by aggregation or flocculation were ignored.

Optionally, embodiments of the present invention can include torque monitoring and/or adjustment and motor speed adjustment achieved via a general or specific purpose computer or distributed system programmed with computer software implementing steps described above, which computer software may be in any appropriate computer language, including but not limited to C++, FORTRAN, BASIC, Java, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

The preceding examples can be repeated with similar success by substituting the generically or specifically described components and/or operating conditions of embodiments of the present invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An inline mixer apparatus comprising:
a variable speed drive unit;
a spindle;
a housing;
an inlet;
a torque monitoring circuit for monitoring torque on said spindle; and
a rotational speed adjusting circuit for adjusting torque on said spindle.

2. The apparatus of claim 1 further comprising a plurality of structures for inducing mixing.

3. The apparatus of claim 2 wherein at least some of said structures are disposed on said spindle.

4. The apparatus of claim 2 wherein at least some of said structures are disposed on an outer portion of said inlet.

5. The apparatus of claim 1 further comprising a cage, said cage comprising one or more structures for inducing mixing.

6. The apparatus of claim 5 wherein said cage comprises an at least substantially cylindrical shape and wherein an outer diameter of said cage is less than an inside diameter of said housing.

7. The apparatus of claim 6 further comprising one or more structures disposed on said cage.

8. The apparatus of claim 1 wherein said variable speed drive unit comprises a variable speed drive motor.

9. The apparatus of claim 1 wherein said variable speed drive unit comprises an adjustable transmission drive unit.

10. An inline mixing system comprising:
an electrically-powered inline mixer, the mixer comprising at least one shaft communicably rotationally-coupled to transmit energy to a fluid passing therethrough; and
a torque control system comprising:
a system for monitoring torque transmitted through said shaft; and
a feedback loop for adjusting power to the electrically-powered inline mixer to adjust torque in the shaft to meet desired criteria.

11. The inline mixer of claim 10 wherein the desired criteria comprises one or more user-adjustable parameters.

12. The inline mixer of claim 10 wherein the desired criteria comprises one or more user-defined magnitudes.

13. The inline mixer of claim 10 wherein the desired criteria comprises one or more predetermined magnitudes.

14. A method for mixing a fluid comprising:
providing an inline mixer comprising a shaft;
monitoring torque on the shaft during a mixing process; and
adjusting a torque output of the inline mixer based on the monitored torque and a predetermined torque parameter.

15. The method of claim 14 wherein providing an inline mixer comprises providing an inline mixer having a variable speed drive unit.

16. The method of claim 14 wherein the predetermined torque parameter comprises a user-defined variable.

17. The method of claim 14 wherein adjusting a torque output of the inline mixer comprises adjusting power to an electric motor of the inline mixer.

18. The method of claim 14 wherein adjusting a torque output of the inline mixer comprises causing an adjustable transmission drive unit to change a torque of its output.

19. The method of claim 14 wherein adjusting a torque output comprises automatically adjusting a torque output via a microcontroller.

20. The method of claim 14 useful for mixing a fluid.

21. The method of claim 20 useful for mixing a flocculant with the fluid.

22. The method of claim 20 useful for mixing a polymer with the fluid.

23. The method of claim 22 wherein the polymer is introduced into the fluid.

24. The method of claim 23 wherein the polymer is injected into the fluid.

25. The method of claim 14 useful for mixing fine tailings and a polymer.

26. The method of claim 25 useful for mixing mature fine tailings and a polymer.
